(19) United States
(12) Patent Application Publication
(10) Pub. No.: US 2026/0106470 A1
(43) Pub. Date: Apr. 16, 2026

(54) SECONDARY BATTERY PROTECTION INTEGRATED CIRCUIT, POWER SYSTEM, AND BATTERY DEVICE

(71) Applicants: Nobuhito TANAKA, Tokyo (JP); Shingo KUBOTA, Tokyo (JP); Junji TAKESHITA, Tokyo (JP)

(72) Inventors: Nobuhito TANAKA, Tokyo (JP); Shingo KUBOTA, Tokyo (JP); Junji TAKESHITA, Tokyo (JP)

(73) Assignee: MITSUMI ELECTRIC CO., LTD., Tokyo (JP)

(21) Appl. No.: 19/350,516

(22) Filed: Oct. 6, 2025

(30) Foreign Application Priority Data
Oct. 10, 2024 (JP) 2024-177981

(51) Int. Cl. H02J 7/00; H01M 50/574

(52) U.S. Cl. CPC H02J 7/60; H01M 50/574; H02J 7/80

(57) ABSTRACT

A secondary battery protection integrated circuit for protecting a secondary battery includes a first terminal to be coupled to an external device, a second terminal coupled to a discharge path, a first switch between a first power terminal and the first terminal, a second switch between a second power terminal and the second terminal, and a control circuit. The control circuit transitions to a discharge interruption state that interrupts the discharge path such that a potential difference between the first terminal and the second terminal is at a first level, causes the first switch and the second switch to become conductive, and turns on a discharge control transistor upon occurrence of a condition in which the potential difference between the first terminal and the second terminal changes from the first level.

### CROSS-REFERENCE TO RELATED APPLICATIONS

This application claims priority under U.S.C. 35 § 119 to Japanese Patent Application No. 2024-177981, filed on Oct. 10, 2024, the contents of which are incorporated herein by reference.

### TECHNICAL FIELD

The present disclosure relates to a secondary battery protection integrated circuit, a power system, and a battery device.

### BACKGROUND

A circuit that protects a secondary battery by turning off a discharge field effect transistor (FET), which is inserted in a charge/discharge current path between a negative electrode of the secondary battery and a negative terminal connected to a ground of a load, has been known (see, e.g., Patent Document 1). This circuit is provided with a terminal to which a control signal is applied. When the control signal is applied to the terminal, the circuit transition to a power-down state and turns off the discharge FET, thereby suppressing power consumption of the secondary battery.

### RELATED-ART DOCUMENTS

### Patent Documents

Patent Document 1: Japanese Unexamined Patent Application Publication No. 2012-257407

### SUMMARY

The present disclosure provides a secondary battery protection integrated circuit for protecting a secondary battery. The secondary battery protection integrated circuit includes:
a first power terminal;
a second power terminal;
a first terminal configured to be coupled to an external device;
a second terminal coupled to a discharge path;
a first switch between the first power terminal and the first terminal;
a second switch between the second power terminal and the second terminal; and
a control circuit configured to:
   interrupt the discharge path by a discharge control transistor in series with the discharge path upon occurrence of a condition in which the first power terminal is coupled to a first electrode of the second battery and the second power terminal is coupled to a second electrode of the second battery,
   transition to a discharge interruption state that interrupts the discharge path such that a potential difference between the first terminal and the second terminal is at a first level,
   cause the first switch and the second switch to become conductive, and
   turn on the discharge control transistor upon occurrence of a condition in which the potential difference between the first terminal and the second terminal changes from the first level.

### BRIEF DESCRIPTION OF THE DRAWINGS

FIG. 1 is a diagram illustrating a configuration example of a power system according to a first embodiment.

FIG. 2 is a diagram illustrating an example of a current path in an OFF state of a power switch in a discharge interruption state.

FIG. 3 is a diagram illustrating an example of the current path in an ON state of the power switch in the discharge interruption state.

FIG. 4 is a timing chart illustrating an operational example of the power system according to the first embodiment.

FIG. 5 is a diagram illustrating an example of the power system in a first modification of the first embodiment.

FIG. 6 is a diagram illustrating an example of the power system in a second modification of the first embodiment.

### DETAILED DESCRIPTION

In a conventional technology that protects a secondary battery, it is necessary to connect a charger to release a power-down state. For this reason, if there is no charger, the power-down state cannot be released, and usability issues may occur in some cases.

The present disclosure provides a technology that improves the convenience of releasing the power-down state.

Hereinafter, embodiments of the present disclosure will be described with reference to the drawings.

### First Embodiment

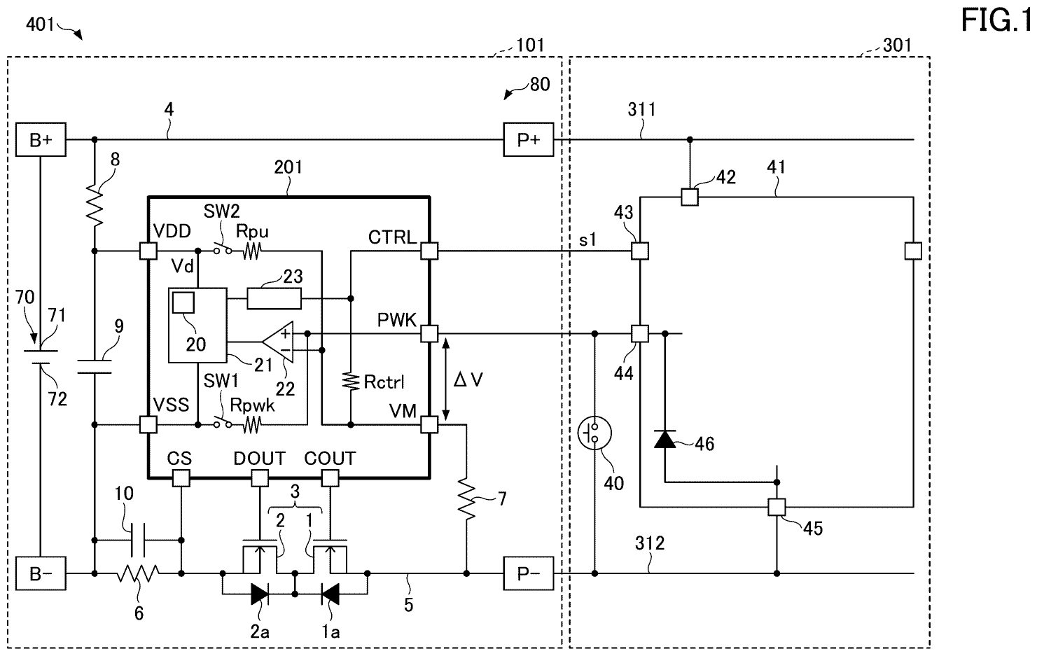

FIG. 1 is a diagram illustrating a configuration example of a power system according to a first embodiment. A power system 401 illustrated in FIG. 1 is a system using a secondary battery 70 as a power source. The power system 401 supplies power to an external device 301. The power system 401 includes a protection integrated circuit (IC) 201, a resistive element 7, a power switch 40, and an external circuit 41. In this example, the protection IC 201 and the resistive element 7 are provided in the battery device 101. The power switch 40 and the external circuit 41 are provided in the external device 301 in this example.

The battery device 101 includes the secondary battery 70 and a battery protection device 80. The secondary battery 70 and the battery protection device 80 are incorporated into the battery device 101. The battery device 101 may be integrated into the external device 301, or may be externally attached to the external device 301. The battery device 101 is, for example, a battery pack.

The secondary battery 70 is an example of a battery that can be charged and discharged. The secondary battery 70 supplies the power to the external device 301 that is electrically connected to terminals P+ and P−. The secondary battery 70 can be charged by a charger that is electrically connected to the terminals P+ and P−. Specific examples of the secondary battery 70 include a lithium ion battery, a lithium polymer battery, and the like. The secondary battery 70 has a positive electrode 71 and a negative electrode 72.

The external device 301 is an example of a load that uses the secondary battery 70 of the battery device 101 as a power source. A specific example of the external device 301 includes a portable device such as a cellular phone, smartphone, a tablet, or earphones. The external device 301 is not limited to these devices.

The battery protection device 80 is an example of a secondary battery protection device that operates using the secondary battery 70 as the power source. The battery protection device 80 protects the secondary battery 70 from overcharging or the like by controlling charging of the secondary battery 70, and protects the secondary battery 70 from overdischarging or the like by controlling discharging of the secondary battery 70. The battery protection device 80 includes the terminal P+, the terminal P−, a terminal B+, a terminal B−, the resistive element 7, a switch circuit 3, and the protection IC 201. The battery protection device 80 is, for example, a component having a substrate on which the protection IC 201 is mounted.

The terminal P+ is an example of a load positive terminal and is electrically connected to a power supply line 311 of the external device 301. The terminal P− is an example of a load negative terminal and is electrically connected to a ground line 312 of the external device 301. The terminal B+ is an example of a battery positive terminal and is electrically connected to the positive electrode 71 of the secondary battery 70. The terminal B− is an example of a battery negative terminal and is electrically connected to the negative electrode 72 of the secondary battery 70.

The terminal B+ and the terminal P+ are connected by a power supply line 4 that is a positive-side current path. The power supply line 4 is a power supply path between the terminal B+ and the terminal P+. The power supply line 4 functions as a charging path through which a charging current of the secondary battery 70 flows, or a discharging path through which a discharging current of the secondary battery 70 flows. The power supply line 4 is an example of a charging/discharging current path between the positive electrode 71 of the secondary battery 70 and the terminal P+.

The terminal B− and the terminal P− are connected by a ground line 5 that is a negative-side current path. The ground line 5 is a current path between the terminal B− and the terminal P−. The ground line 5 functions as a charging path through which the charging current of the secondary battery 70 flows, or a discharging path through which the discharging current of the secondary battery 70 flows. The ground line 5 is an example of a charging/discharging current path between the negative electrode 72 of the secondary battery 70 and the terminal P−. A resistor 8 and a capacitor 9 connected in series are arranged between the terminal B+ and the terminal B−.

The switch circuit 3 is inserted in series into the ground line 5 between the terminal B− and the terminal P−. The switch circuit 3 includes, for example, a charge control transistor 1 and a discharge control transistor 2, and is a series circuit of the charge control transistor 1 and the discharge control transistor 2. The charge control transistor 1 is an example of a charging path interruption section that interrupts the charging path for the secondary battery 70. The discharge control transistor 2 is an example of a discharging path interruption section that interrupts the discharging path for the secondary battery 70.

In the figure, the charge control transistor 1 cuts off the ground line 5 through which the charging current of the secondary battery 70 flows, and the discharge control transistor 2 cuts off the ground line 5 through which the discharge current of the secondary battery 70 flows. The charge control transistor 1 and the discharge control transistor 2 are switching elements for switching conduction and interruption of the ground line 5, and are inserted in series into the ground line 5. The charge control transistor 1 and the discharge control transistor 2 are, for example, N-channel MOSFETs (Metal Oxide Semiconductor Field Effect Transistors).

The charge control transistor 1 has a parasitic diode 1a whose forward direction is opposite to a direction of the charging current of the secondary battery 70, and the parasitic diode 1a is situated between a drain and a source of the charge control transistor 1. The charge control transistor 1 is a switching element inserted in series into the ground line 5 such that the forward direction of the parasitic diode 1a of the charge control transistor 1 coincides with a flow direction of the discharge current of the secondary battery 70.

The discharge control transistor 2 has a parasitic diode 2a whose forward direction is opposite to a direction of the discharge current of the secondary battery 70, and the parasitic diode 2a is situated between a drain and a source of the discharge control transistor 2. The discharge control transistor 2 is a switch element inserted in series to the ground line 5 such that the forward direction of the parasitic diode 2a of the discharge control transistor 2 coincides with a flow direction of the charging current of the secondary battery 70.

A sense resistor 6 is disposed between the switch circuit 3 and the terminal B−. A capacitor 10 is connected in parallel with the sense resistor 6.

The protection IC 201 is an example of a secondary battery protection integrated circuit. The protection IC 201 operates with the secondary battery 70 as the power source. The protection IC 201 is, for example, an integrated circuit (IC) that operates with a battery voltage (which also referred to as a “cell voltage”) across the positive electrode 71 and the negative electrode 72 of the secondary battery 70.

The protection IC 201 protects the secondary battery 70 from overdischarge or the like by controlling the switch circuit 3. For example, the protection IC 201 protects the secondary battery 70 from abnormal charging (such as overcharging or overcurrent in a charging direction (charging overcurrent)) by turning off the charge control transistor 1. On the other hand, the protection IC 201 protects the secondary battery 70 from abnormal discharging (such as overdischarge or overcurrent in a discharge direction (discharge overcurrent)) by turning off the discharge control transistor 2.

The protection IC 201 includes, for example, a charge control terminal (terminal COUT), a discharge control terminal (terminal DOUT), a monitoring terminal (terminal VM), a power supply terminal (terminal VDD), a ground terminal (terminal VSS), a current detection terminal (terminal CS), a control input terminal (terminal CTRL), and a power key terminal (terminal PWK). These terminals are external connection terminals for connecting an internal circuit of the protection IC 201 to the outside of the protection IC 201.

The terminal COUT is connected to a gate (control terminal) of the charge control transistor 1 and outputs a signal to turn on and off the charge control transistor 1. The terminal DOUT is connected to a gate (control terminal) of the discharge control transistor 2 and outputs a signal to turn on and off the discharge control transistor 2.

The terminal VM is used for monitoring a potential at the terminal P−, and is electrically connected to the terminal P− via the resistive element 7. The terminal VM is used, for example, when a detection circuit in the protection IC 201 monitors whether the external device 301 or the charger is connected. The terminal VM is electrically connected to the ground line 5 between the switch circuit 3 and the terminal P−.

The terminal VDD is a power supply terminal of the protection IC 201, and is electrically connected to the positive electrode 71 of the secondary battery 70 and the power supply line 4. The terminal VSS is a ground terminal of the protection IC 201, and is electrically connected to the negative electrode 72 of the secondary battery 70 and the ground line 5. The terminal VSS is electrically connected to the ground line 5 between the switch circuit 3 and the terminal B−. In other words, the terminal VSS is electrically connected to the ground line 5 between the discharge control transistor 2 and the negative electrode 72. In this example, the terminal VSS is electrically connected to the ground line 5 between the sense resistor 6 and the negative electrode 72.

The terminal VDD is electrically connected to the terminal VM inside the protection IC 201 via a switch SW2 and a resistor Rpu. The switch SW2 is an internal switch incorporated in the protection IC 201. The resistor Rpu is an internal resistor incorporated in the protection IC 201.

The terminal CS is electrically connected to the ground line 5 between the discharge control transistor 2 of the switch circuit 3 and the sense resistor 6. The sense resistor 6 is a current detection resistor inserted in series to the ground line 5 between the switch circuit 3 and the terminal B−. The sense resistor 6 is inserted in series to the ground line 5, between the discharge control transistor 2 and the negative electrode 72.

The terminal CTRL is electrically connected to the terminal 43 of the external circuit 41 in the external device 301. The terminal CTRL is electrically connected to the terminal VM through a control resistor Rctrl in the protection IC 201. The terminal CTRL is an input terminal to which a signal is applied from the external device 301. The terminal CTRL receives a predetermined first signal s1 output from the external circuit 41. The first signal s1 is, for example, a signal to instruct a reduction in power consumption of the protection IC 201, and is also referred to as a forced shutdown signal.

A terminal PWK is electrically connected to the power switch 40 and a terminal 44 of the external circuit 41. The terminal PWK is electrically connected to a terminal VSS via a switch SW1 and a resistor Rpwk in the protection IC 201. The switch SW1 is an internal switch incorporated in the protection IC 201. The resistor Rpwk is an internal resistor incorporated into the protection IC 201.

The protection IC 201 performs protection of the secondary battery 70. The protection IC 201 includes an abnormality detection circuit 20 and a control circuit 21. The abnormality detection circuit 20 is an example of a device that detects abnormality of current or voltage of the secondary battery 70. The control circuit 21 has a switch control circuit that controls on/off of the charge control transistor 1 or the discharge control transistor 2 of the switch circuit 3 based on an abnormality detection result by the abnormality detection circuit 20. The control circuit 21 and the switch control circuit are each configured by, for example, a logic circuit.

The abnormality detection circuit 20 monitors the power supply voltage Vd between the terminal VDD and the terminal VSS. When the abnormality detection circuit 20 detects the power supply voltage Vd that is higher than a predetermined overcharge detection voltage VDET1, the control circuit 21 turns off the charge control transistor 1. When the abnormality detection circuit 20 detects the power supply voltage Vd that is lower than a predetermined overcharge return voltage VREL1, the control circuit 21 turns on the charge control transistor 1. When the abnormality detection circuit 20 detects the power supply voltage Vd that is lower than a predetermined overdischarge detection voltage VDET2, the control circuit 21 turns off the discharge control transistor 2. When the abnormality detection circuit 20 detects the power supply voltage Vd that is higher than a predetermined overdischarge return voltage VREL2, the control circuit 21 turns on the discharge control transistor 2.

The protection IC 201 includes a detection circuit 23 and a comparison circuit 22.

The detection circuit 23 is electrically connected to the terminal CTRL and to the terminal VM via the resistor Rctrl. The detection circuit 23 monitors the presence or absence of the input of the first signal s1. When the input of the first signal s1 is detected, the detection circuit 23 outputs, to the control circuit 21, a detection signal having an active level indicating that the input of the first signal s1 is detected. When the input of the first signal s1 is not detected, the detection circuit 23 outputs, to the control circuit 21, a detection signal having an inactive level indicating that the input of the first signal s1 is not detected. When the first signal s1 is a logic signal having a high level or a low level, the detection circuit 23 has a configuration capable of detecting the logic level of the logic signal. The detection circuit 23 is, for example, a circuit including a complementary metal oxide semiconductor (CMOS) structure to which the first signal s1 is input.

An output of the comparison circuit 22 is electrically connected to the control circuit 21, and an input of the comparison circuit 22 is electrically connected to the terminal PWK and the terminal VM. The comparison circuit 22 monitors a change in a potential difference AV between the terminal PWK and the terminal VM, and outputs a monitoring result to the control circuit 21. The comparison circuit 22 includes, for example, a comparator. The comparator has a non-inverting input terminal that is electrically connected to the terminal PWK, an inverting input terminal that is electrically connected to the terminal VM, and an output terminal that is electrically connected to the control circuit 21.

The external device 301 includes the power switch 40 and the external circuit 41.

The power switch 40 is provided outside the protection IC 201, and is provided outside the battery device 101 in this example. The power switch 40 has a first switch end electrically connected to the terminal PWK and the terminal 44, and has a second switch end electrically connected to the terminal P− and the terminal 45. The second switch end is electrically connected to the terminal VM through the terminal P− and the resistive element 7. The power switch 40 is an element that is turned on or off by a user operation, for example. The power switch 40 is, for example, a switch that powers on the external device 301. The power switch 40 may have a function of powering on the external device 301 in addition to a function of powering off the external device 301.

The external circuit 41 operates with a power supply voltage that is supplied between the terminal 42, which is electrically connected to the power supply line 311, and the terminal 45, which is electrically connected to the ground line 312. The external circuit 41 is, for example, a semiconductor integrated circuit including a power supply circuit.

When a predetermined condition (which may be referred to as a “shutdown condition”) is satisfied, the external circuit 41 outputs a first signal s1 (forced shutdown signal) from the terminal 43. For example, the shutdown condition includes at least a case where, when the power supply voltage between the terminal 42 and the terminal 45 is normal voltage of a reset voltage or higher, an input voltage between the terminal 42 and the terminal 45 is maintained at or below a predetermined voltage value for a predetermined input time. For example, at the time of product shipment, by outputting the first signal s1 from the external circuit 41 via the terminal 43, power consumption of the secondary battery 70 can be reduced during product storage.

The external circuit 41 has a diode 46 connected to the terminal 44 and the terminal 45. The diode 46 is connected between the terminal 44 and the terminal 45 inside the external circuit 41. However, the diode 46 may be connected between the terminal 44 and the terminal 45 outside the external circuit 41. The diode 46 has an anode electrically connected to the terminal 45, and has a cathode electrically connected to the terminal 44. Examples of the diode 46 include a parasitic diode formed between the terminal 44 and the terminal 45, and an electrostatic protection diode or the like provided between the terminal 44 and the terminal 45.

Hereinafter, transition of an operation mode of the protection IC 201 will be described.

In normal mode, the control circuit 21 of the protection IC 201 turns on the charge control transistor 1 and the discharge control transistor 2. The normal mode is a state where a voltage is supplied from the secondary battery 70 to the external circuit 41. When the discharge control transistor 2 is turned on, an output voltage of the battery device 101 (a voltage between the terminals P+ and P−) is approximately equal to a cell voltage of the secondary battery 70. In the normal mode, by turning off the switch SW1, the control circuit 21 interrupts conduction between the terminal PWK and the terminal VSS and interrupts conduction between the terminal VDD and the terminal VM by turning off the switch SW2.

When a predetermined condition is satisfied, the external circuit 41 of the external device 301 outputs the first signal s1 (forced shutdown signal) from the terminal 43.

In the normal mode, when the input of the first signal s1 is detected by the detection circuit 23, the control circuit 21 shifts the operation mode of the protection IC 201 from the normal mode to ship mode. The ship mode is a mode for reducing power consumption when the secondary battery 70 is stored. The ship mode is also called power saving mode.

The ship mode is both a discharge interruption state in which the discharge control transistor 2 is turned off and a state in which the switch SW1 and the switch SW2 are conductive. In the ship mode, by making the switch SW1 conductive, the control circuit 21 makes a path between the terminal PWK and the terminal VSS conductive through the switch SW1 and the resistor Rpwk. In the ship mode, by making the switch SW2 conductive, the control circuit 21 makes a path between the terminal VDD and the terminal VM conductive through the switch SW2 and the resistor Rpu. In the ship mode, by turning off the discharge control transistor 2, the control circuit 21 interrupts the discharging path for the secondary battery 70.

In the ship mode, by turning off the discharge control transistor 2 and making the switch SW2 conductive (on), the output voltage (the voltage between the terminal P+ and the terminal P−) of the battery device 101 becomes approximately zero. Thus, the external circuit 41 stops, and current consumption of the external device 301 is reduced. On the other hand, in the ship mode, the control circuit 21 cuts off the power to the abnormality detection circuit 20. By cutting off the power to the abnormality detection circuit 20, current consumption of the protection IC 201 is reduced.

Hereinafter, return (transition) from the ship mode to the normal mode will be described.

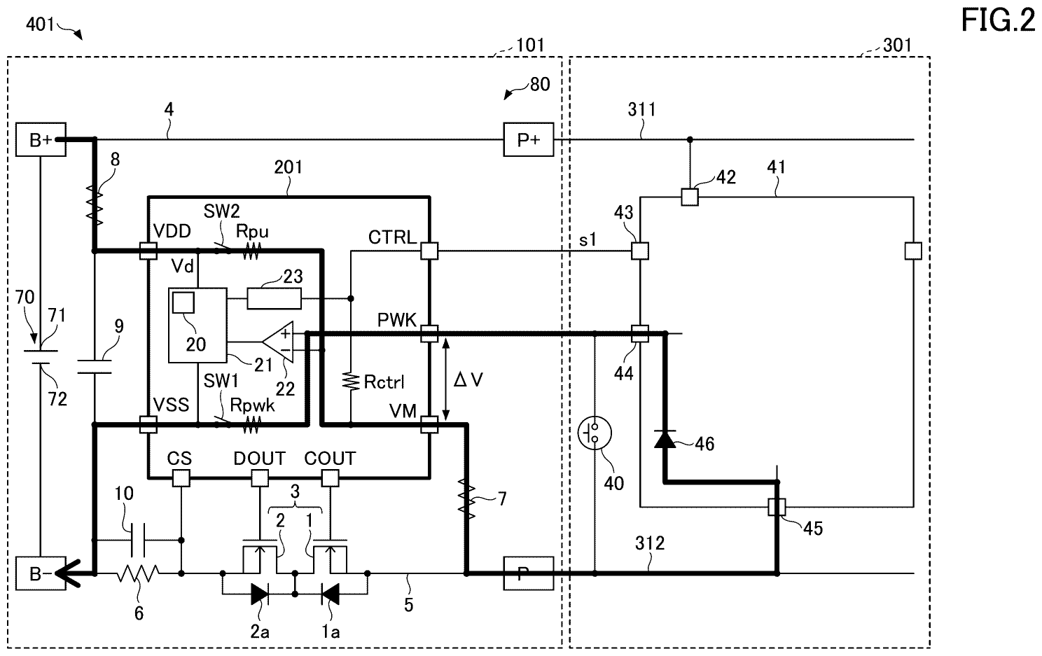

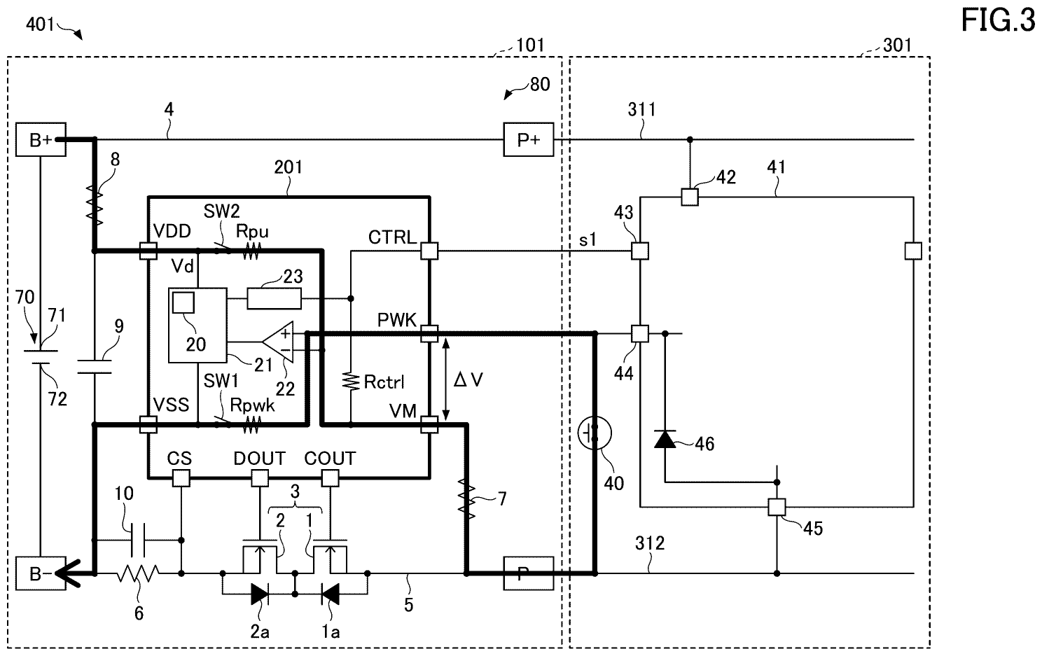

In the ship mode, by making the switch SW1 conductive, the control circuit 21 provides a conductive connection between the terminal PWK and the terminal VSS and makes the switch SW2 conductive, thereby providing a conductive connection between the terminal VDD and the terminal VM. In this arrangement, in the ship mode, when the power switch 40 is in an OFF state, the current flows along the path indicated by an arrow illustrated in FIG. 2. In such a state in FIG. 2, when the power switch 40 is in an ON state where a user has turned on the power switch 40, the current flows along a path indicated by an arrow illustrated in FIG. 3.

In the case of FIG. 2, the current flows sequentially through the positive electrode 71, the terminal B+, the terminal VDD, the resistor Rpu, the terminal VM, the resistive element 7, the terminal P−, the terminal 45, the diode 46, the terminal 44, the terminal PWK, the resistor Rpwk, the terminal VSS, the terminal B−, and the negative electrode 72. In the case of FIG. 3, the current flows sequentially through the positive electrode 71, the terminal B+, the terminal VDD, the resistor Rpu, the terminal VM, the resistive element 7, the terminal P−, the power switch 40, the terminal PWK, the resistor Rpwk, the terminal VSS, the terminal B−, and the negative electrode 72. In this arrangement, in the ship mode, a voltage difference between forward voltages of the diode 46 occurs in a potential difference ΔV between the terminal PWK and the terminal VM when the power switch 40 is ON and when the power switch 40 is OFF. By detecting the change in the potential difference ΔV, the control circuit 21 shifts (returns) the operation mode of the protection IC 201 from the ship mode to the normal mode. Here, when the power switch 40 is ON, the current path from the terminal VM to the terminal PWK becomes a path through the power switch 40. In this case, when the power switch 40 is pressed, the current path from the terminal VM to the terminal PWK can be changed simultaneously with starting the external device 301. As a result, a circuit that detects that the external device 301 is powered becomes unnecessary.

In the first embodiment, the control circuit 21 turns on the discharge control transistor 2 when detecting a change in the potential difference ΔV in the discharge interruption state (ship mode). The control circuit 21 turns on the switch SW1 and the switch SW2 in the discharge interruption state. For example, in the discharge interruption state (ship mode), the potential difference ΔV in the OFF state of the power switch 40 is set as a first level. At this time, when the potential difference ΔV changes from the first level in the ship mode, the control circuit 21 determines that the power switch 40 has changed from the OFF state to the ON state and turns on the discharge control transistor 2. Thus, the operation mode of the protection IC 201 transitions (returns) from the ship mode to the normal mode.

The first level is generated by the potential difference between the terminal 45 and the terminal 44. In this example, the first level is generated by the forward voltage of the diode 46 and is equal to or less than the forward voltage of the diode 46. Although a potential difference generated across the resistive element 7 is also a factor that generates the first level, this potential difference is less than the forward voltage of the diode 46 and is negligible. This potential difference can be generated by a component other than the diode, such as a resistive element or a transistor.

In the ship mode, since the power to the external circuit 41 is cut off by turning off the discharge control transistor 2, the external circuit 41 cannot detect the power switch 40 is on and cannot output a control signal for canceling the ship mode to the protection IC 201.

However, according to the first embodiment, in the discharge interruption state (ship mode), since the switch SW1 and the switch SW2 are conductive and the discharge control transistor 2 is not conductive, the control circuit 21 can detect a change in the potential difference ΔV that is linked to the power switch 40 being on. When the potential difference ΔV changes from the first level in the ship mode, the control circuit 21 can shift (return) the operation mode of the protection IC 201 from the ship mode to the normal mode by turning on the discharge control transistor 2. As a result, since the ship mode is released by turning on the power switch 40 without connecting a charger, the convenience of releasing the power-down state is improved.

In the first embodiment, the terminal VSS is an example of a first power terminal. The terminal VDD is an example of a second power terminal. The negative electrode 72 is an example of a first electrode. The positive electrode 71 is an example of a second electrode. The ground line 5 is an example of a discharge path connected to the first electrode. The terminal PWK is an example of a first terminal connected to an external device. The terminal VM is an example of a second terminal connected to the discharge path. The switch SW1 is an example of a first switch disposed between the first power terminal and the first terminal. The switch SW2 is an example of a second switch disposed between the second power terminal and the second terminal. The terminal 45 is an example of a third power terminal connected to the discharge path. The terminal 44 is an example of a third terminal connected to the first terminal. The terminal P− or the terminal 45 is an example of a ground terminal.

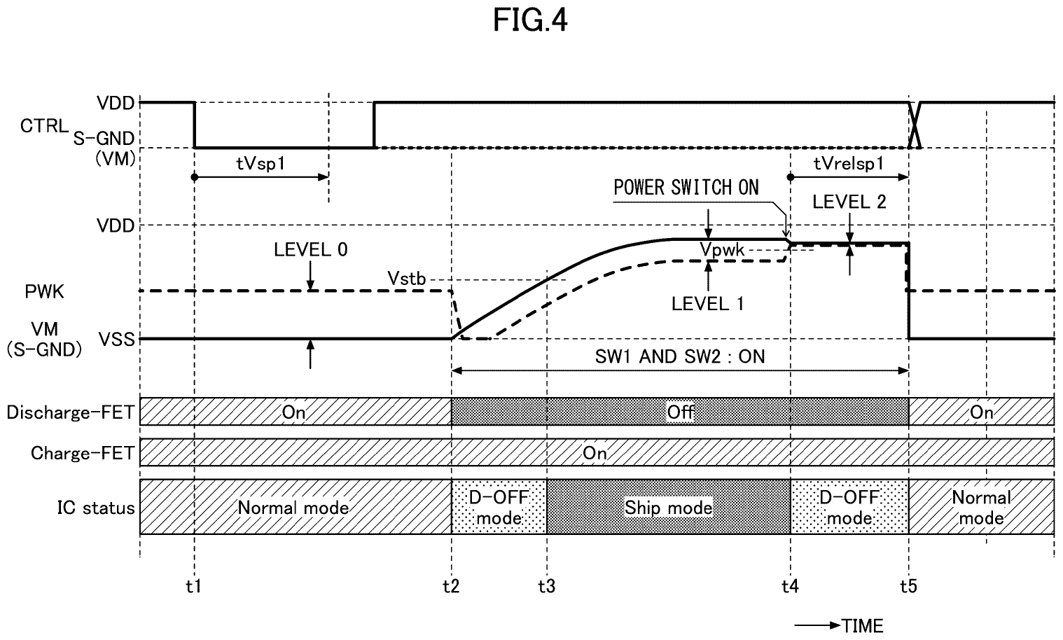

FIG. 4 is a timing chart illustrating an operational example of the power system according to the first embodiment. FIG. 4 illustrates the transition of the operation mode of the protection IC 201. Hereinafter, FIG. 4 will be described with reference to FIG. 1.

In FIG. 4, “CTRL” represents a voltage level of the terminal CTRL (a voltage level of the first signal s1 input to the terminal CTRL). “PWK” represents a voltage level of the terminal PWK. “VM” represents a voltage level of the terminal VM. A level difference between PWK and VM corresponds to the potential difference ΔV.

In the normal mode, the control circuit 21 of the protection IC 201 turns on the charge control transistor 1 and the discharge control transistor 2.

When a predetermined condition is satisfied, the external circuit 41 of the external device 301 makes the first signal s1 output from the terminal 43 active at time t1 (in this example, a logic level of the first signal s1 is set to a low level). The external circuit 41 maintains the first signal s1 in an active state during a period when the predetermined condition is satisfied.

In the normal mode, when the active first signal s1 is input, the control circuit 21 shifts the operation mode of the protection IC 201 from the normal mode to the ship mode (discharge interruption state). In this example, when the active first signal s1 continues for a predetermined input time period tVsp1 or longer, the control circuit 21 shifts the operation mode of the protection IC 201 from the normal mode to the ship mode via a discharge-off mode (D-OFF mode). Here, the potential difference ΔV in the normal mode becomes the 0th level.

The control circuit 21 turns off the discharge control transistor 2 at time t2 when the active first signal s1 is continuously input for the predetermined input time period tVsp1 or longer. As a result, the operation mode of the protection IC 201 transitions from the normal mode to the discharge-off mode.

Since the output voltage of the battery device 101 becomes approximately zero when the discharge control transistor 2 is off, the external circuit 41 stops, and thus current consumption of the external device 301 decreases. On the other hand, in the discharge-off mode, the control circuit 21 turns off the discharge control transistor 2 and turns on the switch SW1 and the switch SW2. In this case, since the current flows along the path illustrated in FIG. 2 when the power switch 40 is off, the voltage at the terminal VM gradually increases from approximately zero. On the other hand, the voltage at the terminal PWK temporarily decreases to approximately zero by turning on the switch SW1, and then gradually increases from approximately zero by the current flowing as illustrated in FIG. 2. In this case, the voltages at the terminal VM and the terminal PWK gradually increase while the potential difference ΔV is maintained at the first level.

When the voltage at the terminal VM increases to a predetermined standby voltage Vstb or higher at time t3, the control circuit 21 shifts the operation mode of the protection IC 201 from the discharge-off mode to the ship mode. The control circuit 21 cuts off the power to the abnormality detection circuit 20 in the ship mode. By cutting off the power to the abnormality detection circuit 20, the current consumption of the protection IC 201 is reduced.

Next, in the ship mode, when the power switch 40 is turned on at time t4, the current flows along the path as illustrated in FIG. 3, and thus the potential difference ΔV drops below the first level. At time t5 when the potential difference ΔV changes from the first level in the ship mode (discharge interruption state) and the changed level (second level) is maintained for a predetermined time period tVrelsp1 or longer, the control circuit 21 turns on the discharge control transistor 2 and opens (turns off) the switch SW1 and the switch SW2. As a result, the operation mode of the protection IC 201 transitions (returns) from the ship mode to the normal mode. The second level of the potential difference ΔV is lower than the first level. The comparison circuit 22 detects the change in the potential difference AV and transmits an output detected by the comparison circuit 22 to the control circuit 21.

The control circuit 21 does not need to simultaneously turn on the discharge control transistor 2, turn off the switch SW1, and turn off the switch SW2 at the time t5, and time differences may be provided between these timings.

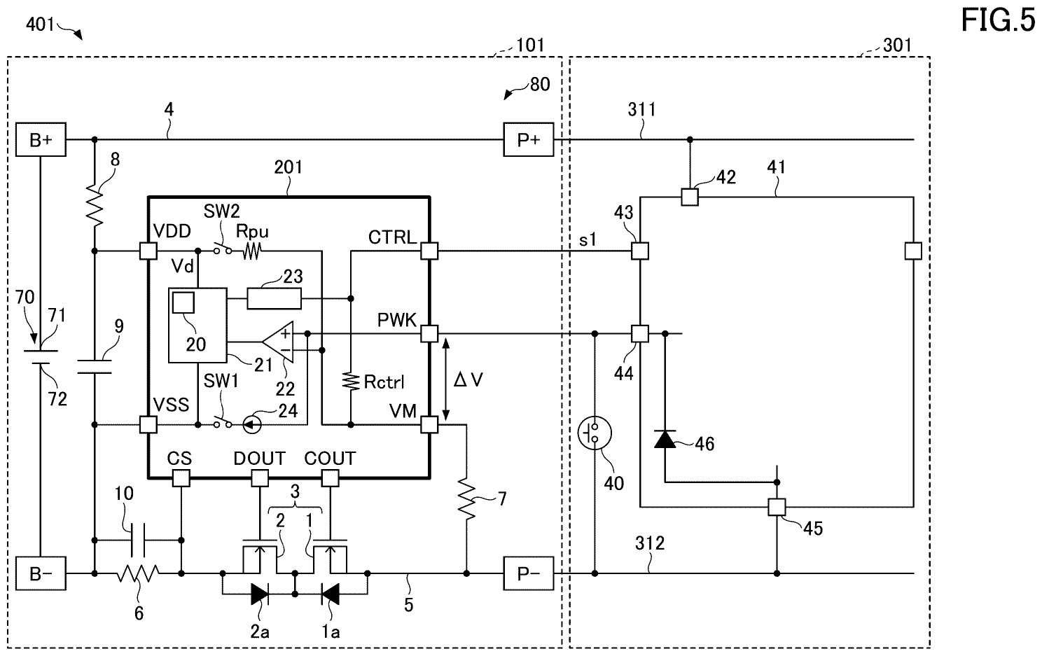

FIG. 5 is a diagram illustrating the power system in a first modification of the first embodiment. The resistor Rpwk (see FIG. 1) connected in series with the switch SW2 may be replaced by a constant current source 24 as illustrated in FIG. 5. The constant current source 24 can stably reduce power consumption because the constant current source 24 keeps a value of the current flowing in the ship mode illustrated in FIG. 2 or FIG. 3 constant. Similarly, the resistor Rpu (see FIG. 1) connected in series with the switch SW1 may be replaced by the constant current source.

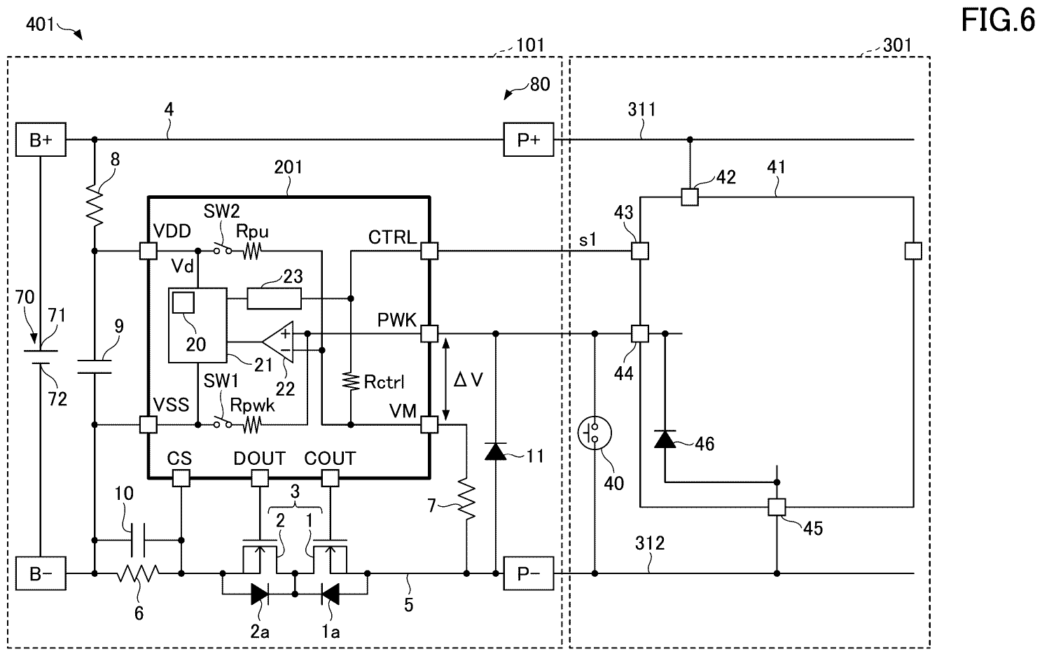

FIG. 6 is a diagram illustrating the power system in a second modification of the first embodiment. The diode 11 may be mounted on the battery device 101, or may be disposed between the terminal PWK and the terminal VM. The diode 11 has an anode electrically connected to the terminal VM via the resistive element 7 and a cathode electrically connected to the terminal PWK. Since the current flows through the diode 11 in the ship mode, a change in the potential difference ΔV can occur between when the power switch 40 is on and when the power switch 40 is off.

Further, the potential difference ΔV is generated by using a circuit element (for example, a diode 46) incorporated into the external circuit 41. As a result, for example, an external resistor for generating the potential difference ΔV becomes unnecessary.

Although the embodiments have been described as above, the embodiments are presented by way of example, and the present disclosure is not limited to the embodiments. The embodiments can be practiced in various other forms, and various combinations, omissions, substitutions, modifications, and the like can be made without departing from the gist of the disclosure. These embodiments and modifications thereof are included in the scope and gist of the present disclosure, and its equivalents falls within the scope of the disclosure.

Further, for example, the arrangement positions of the charge control transistor 1 and the discharge control transistor 2 may be interchanged from those illustrated in the drawings. Further, the switch circuit 3 may be incorporated into a secondary battery protection integrated circuit.

1. A secondary battery protection integrated circuit including a first power terminal and a second power terminal and configured to protect a secondary battery by interrupting a discharge path by a discharge control transistor in series with the discharge path upon occurrence of a condition in which the first power terminal is coupled to a first electrode of the second battery and the second power terminal is coupled to a second electrode of the second battery, comprising:
a first terminal configured to be coupled to an external device;
a second terminal coupled to the discharge path;
a first switch between the first power terminal and the first terminal;
a second switch between the second power terminal and the second terminal; and
a control circuit configured to:
transition to a discharge interruption state that interrupts the discharge path, and
cause the first switch and the second switch to become conductive,
wherein, in the discharge interruption state, a potential difference between the first terminal and the second terminal is at a first level, and
wherein the control circuit is configured to turn on the discharge control transistor upon occurrence of a condition in which the potential difference between the first terminal and the second terminal changes from the first level.

2. The secondary battery protection integrated circuit according to claim 1, wherein the control circuit is configured to turn on the discharge control transistor upon occurrence of the condition in which in the discharge interruption state, the potential difference between the first terminal and the second terminal changes from the first level, in conjunction with a condition in which the changed first level continues for a predetermined time period or longer.

3. The secondary battery protection integrated circuit according to claim 2, wherein the control circuit is configured to turn off the first switch upon occurrence of the condition in which in the discharge interruption state, the potential difference between the first terminal and the second terminal changes from the first level, in conjunction with the condition in which the changed level continues for the predetermined time period or longer.

4. The secondary battery protection integrated circuit according to claim 3, wherein the control circuit is configured to turn off the second switch upon occurrence of the condition in which in the discharge interruption state, the potential difference between the first terminal and the second terminal changes from the first level, in conjunction with the condition in which the changed level continues for the predetermined time period or longer.

5. The secondary battery protection integrated circuit according to claim 1, further comprising:
a comparison circuit including an output coupled to the control circuit and an input coupled to the first terminal and the second terminal.

6. The secondary battery protection integrated circuit according to claim 1, further comprising:
an input terminal to which a signal is to be input from the external device,
wherein the control circuit is configured to transition to the discharge interruption state upon occurrence of a condition in which a first signal is input from the external device.

7. The secondary battery protection integrated circuit according to claim 6, wherein the external device includes a third power terminal to be coupled to the discharge path and a third terminal to be coupled to the first terminal, and
wherein the first level is to be generated by a potential difference between the third power terminal and the third terminal.

8. The secondary battery protection integrated circuit according to claim 7, wherein the first level is to be generated using a diode coupled to the third power terminal and the third terminal.

9. The secondary battery protection integrated circuit according to claim 1, wherein the first level is to be generated using a diode between the first terminal and the second terminal.

10. The secondary battery protection integrated circuit according to claim 8, wherein the first level is less than or equal to a forward voltage of the diode.

11. A power system comprising:
the secondary battery protection integrated circuit of claim 1;
a power switch configured to activate the external device, and including one end coupled to a ground terminal and another end coupled to the first terminal; and
a resistive element between the second terminal and the discharge path.

12. The power system according to claim 11, wherein a current path from the first terminal to the second terminal is to become a path through the power switch upon occurrence of a condition in which the power switch is turned on.

13. A battery device comprising:
the secondary battery protection integrated circuit of claim 1;
the secondary battery; and
the discharge control transistor.
